(19) United States
(12) Patent Application Publication
(10) Pub. No.: US 2024/0297722 A1
(43) Pub. Date: Sep. 5, 2024

(54) Gating Apparatus for Single-photon Detector and Quantum Communication Device

(71) Applicant: QUDOOR TECHNOLOGIES INC., Beijing (CN)

(72) Inventors: Liuping CHEN, Beijing (CN); Yongsheng FAN, Beijing (CN); Qibing WANG, Beijing (CN); Xiangkui WAN, Beijing (CN); Nan LI, Beijing (CN); Zhenyang JIN, Beijing (CN)

(21) Appl. No.: 18/682,917

(22) PCT Filed: Aug. 12, 2022
(86) PCT No.: PCT/CN2022/111947

§ 371 Date: Feb. 11, 2024

(30) Foreign Application Priority Data
Aug. 12, 2021 (CN) 202110921945.7

(51) Int. Cl. H04B 10/70; G01J 1/44; H04L 9/08

(52) U.S. Cl. CPC H04B 10/70; G01J 1/44; H04L 9/0858; G01J 2001/442; G01J 2001/444

(57) ABSTRACT

The disclosure provides a gating apparatus for a single-photon detector and a quantum communication device. The gating apparatus includes: a system synchronization unit, configured to obtain a periodic gating signal synchronized with a clock of a quantum communication system; a clock distributor, configured to divide the periodic gating signal into two periodic gating signals; a delay unit, configured to delay one periodic gating signal of the two periodic gating signals, so that the one periodic gating signal and the other periodic gating signal of the two periodic gating signals are spaced apart by predetermined duration; and a logical OR gate, configured to perform an OR operation on the one periodic gating signal delayed and the other periodic gating signal undelayed of the two periodic gating signals, so as to generate a periodic gating signal sequence synchronized with the clock of the quantum communication system.

### TECHNICAL FIELD

The disclosure relates to the technical field of quantum communication, in particular to a gating apparatus for a single-photon detector and a quantum communication device.

### BACKGROUND

In order to detect a optical pulse transmitted in an existing quantum communication system, a periodic gating signal as shown in FIG. 5B is generally applied to a single-photon detector for activating gating of the single-photon detector. However, caused by the use of the single periodic gating signal, a dark count and a after pulse count in the single-photon detector will be increased by the use of the single periodic gating signal at a high repetition frequency. In consequence, the error rate of the quantum communication system will be increased during secret key generation, and further the final key rate of the system will be decreased.

### SUMMARY

In order to solve the above problems, the disclosure provides a gating apparatus for a single-photon detector and a quantum communication device.

According to one aspect of the disclosure, a gating apparatus for a single-photon detector is provided. The gating apparatus includes: a system synchronization unit, configured to obtain a periodic gating signal synchronized with a clock of a quantum communication system; a clock distributor, configured to divide the periodic gating signal into two identical periodic gating signals; a delay unit, configured to delay one periodic gating signal of the two periodic gating signals, so that the one periodic gating signal and the other periodic gating signal of the two periodic gating signals are spaced apart by predetermined duration, where the predetermined duration is an optical path difference between a long arm and a short arm of an unequal-arm interferometer used for phase encoding in the quantum communication system; and a logical OR gate, configured to perform an OR operation on the one periodic gating signal delayed and the other periodic gating signal undelayed of the two periodic gating signals, so as to generate a periodic gating signal sequence synchronized with the clock of the quantum communication system, where gating signals in each gating signal sequence of the periodic gating signal sequence are spaced apart from each other by the predetermined duration, such that gating of the single-photon detector in the quantum communication system is activated for a optical pulse received by the single-photon detector.

According to another aspect of the disclosure, a quantum communication device is provided. The quantum communication device includes the gating apparatus for a single-photon detector.

According to the gating apparatus for a single-photon detector and the quantum communication device provided by the disclosure, a dark count and a after pulse count caused by using a periodic gating signal with a high repetition frequency in a high-frequency operation process by the single-photon detector in the quantum communication system can be effectively decreased, and the error rate of the quantum communication system during secret key generation can be greatly decreased. In addition, according to the gating apparatus for a single-photon detector and the quantum communication device provided by the disclosure, numbers of single-photon detectors and polarization beam splitters used in the quantum communication system are significantly decreased. As a result, a cost of system implementation can be greatly decreased, and insertion loss caused by using additional polarization beam splitters can be further avoided.

### BRIEF DESCRIPTION OF THE DRAWINGS

The above objectives and features of the disclosure will become clearer from the following description in conjunction with accompanying drawings.

FIG. 1A is a schematic diagram of a gating apparatus for a single-photon detector according to an illustrative example of the disclosure.

FIG. 1B is a schematic diagram of a signal time series of an operation process of a gating apparatus for a single-photon detector according to an illustrative example of the disclosure.

FIG. 2A is another schematic diagram of a gating apparatus for a single-photon detector according to an illustrative example of the disclosure.

FIG. 2B is another schematic diagram of a signal time series of an operation process of a gating apparatus for a single-photon detector according to an illustrative example of the disclosure.

FIG. 3A is a schematic diagram of a narrow pulse generation unit in a gating apparatus for a single-photon detector according to an illustrative example of the disclosure.

FIG. 3B is a schematic diagram of a signal time series of an operation process of a narrow pulse generation unit in a gating apparatus for a single-photon detector according to an illustrative example of the disclosure.

FIG. 4 is a schematic diagram of a system synchronization unit in a gating apparatus for a single-photon detector according to an illustrative example of the disclosure.

FIG. 5A is a schematic diagram of a quantum communication system based on time phase encoding in the related art.

FIG. 5B is a schematic diagram of applying a gating signal to a single-photon detector in the quantum communication system shown in FIG. 5A for detecting time codes carried by a optical pulse in the related art.

FIG. 6A is a schematic diagram of a quantum communication system based on time phase encoding according to an illustrative example of the disclosure.

FIG. 6B is a schematic diagram of applying a gating signal to a single-photon detector in the quantum communication system shown in FIG. 6A by using a gating apparatus for a single-photon detector according to an illustrative example of the disclosure for detecting time codes carried by a optical pulse.

FIG. 7 is a schematic diagram showing a comparison between a periodic gating signal that is output in the related art and a periodic gating signal sequence that is output by a gating apparatus for a single-photon detector according to an illustrative example of the disclosure.

### DETAILED DESCRIPTION OF THE EMBODIMENTS

Examples of the disclosure will be described in detail below with reference to accompanying drawings.

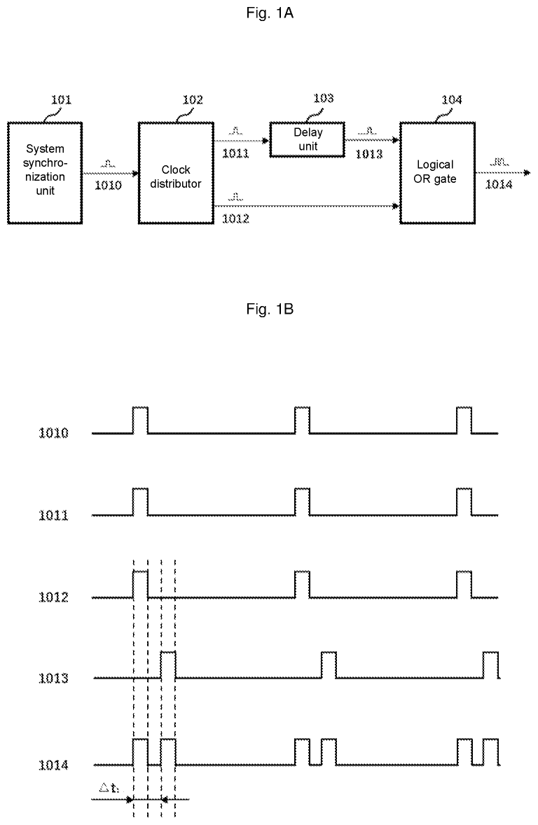

FIG. 1A is a schematic diagram of a gating apparatus for a single-photon detector according to an illustrative example of the disclosure. FIG. 1B is a schematic diagram of a signal time series of an operation process of a gating apparatus for a single-photon detector according to an illustrative example of the disclosure.

With reference to FIGS. 1A and 1B, the gating apparatus for a single-photon detector according to the illustrative example of the disclosure may at least include a system synchronization unit 101, a clock distributor 102, a delay unit 103, and a logical OR gate 104.

In the gating apparatus shown in FIG. 1A, the system synchronization unit 101 may be configured to obtain a periodic gating signal 1010 synchronized with a clock (that is, a clock of an encoded signal of a quantum communication system) of the quantum communication system. The clock distributor 102 may be configured to divide the periodic gating signal 1010 into two identical periodic gating signals 1011 and 1012. The delay unit 103 may be configured to delay one periodic gating signal 1011, so that the one periodic gating signal 1011 and the other periodic gating signal 1012 are spaced apart by predetermined duration Δt₁, where the predetermined duration Δt₁ may be an optical path difference between a long arm and a short arm of an unequal-arm interferometer used for phase encoding in the quantum communication system. The logical OR gate 104 may be configured to perform an OR operation on the one periodic gating signal 1013 delayed and the other periodic gating signal 1012 undelayed, so as to generate a periodic gating signal sequence 1014 synchronized with the clock of the quantum communication system, where gating signals in each gating signal sequence are spaced apart from each other by the predetermined duration Δt₁, such that gating of the single-photon detector in the quantum communication system is activated for a optical pulse received by the single-photon detector (in other words, the single-photon detector in the quantum communication system operates in a Geiger mode for the optical pulse received). In this way, a dark count and a after pulse count caused by unnecessary repetition of the gating signal by the single-photon detector in the quantum communication system can be decreased to the greatest extent.

In the gating apparatus shown in FIG. 1A, the quantum communication system may be based on time phase encoding or may be based on phase encoding. As an instance, in the quantum communication system based on time phase encoding, the periodic gating signal sequence 1014 output by the gating apparatus shown in FIG. 1A may be used to activate gating of the single-photon detector for the optical pulse carrying time codes received from the quantum communication system, or activate gating of the single-photon detector for the optical pulse carrying phase codes received from the quantum communication system, or activate gating of the single-photon detector for both the optical pulses carrying phase codes and the optical pulses carrying time codes received from the quantum communication system.

It should be understood that although each periodic gating signal sequence of the periodic gating signal sequences 1014 shown in FIG. 1B includes two gating signals that are spaced apart from each other by the predetermined duration Δt₁, the disclosure is not limited thereto. Additional devices other than those shown in FIG. 1A may be used as needed (including but not limited to additional clock distributors, delay units and logical OR gates may be used), such that each gating signal sequence of the periodic gating signal sequences includes more gating signals than each gating signal sequence of the periodic gating signal sequences 1014 shown in FIG. 1B. In this way, numbers of single-photon detectors and polarization beam splitters used in the quantum communication system can be significantly decreased, a cost of system implementation can be greatly decreased, and insertion loss caused by using additional polarization beam splitters can be further avoided.

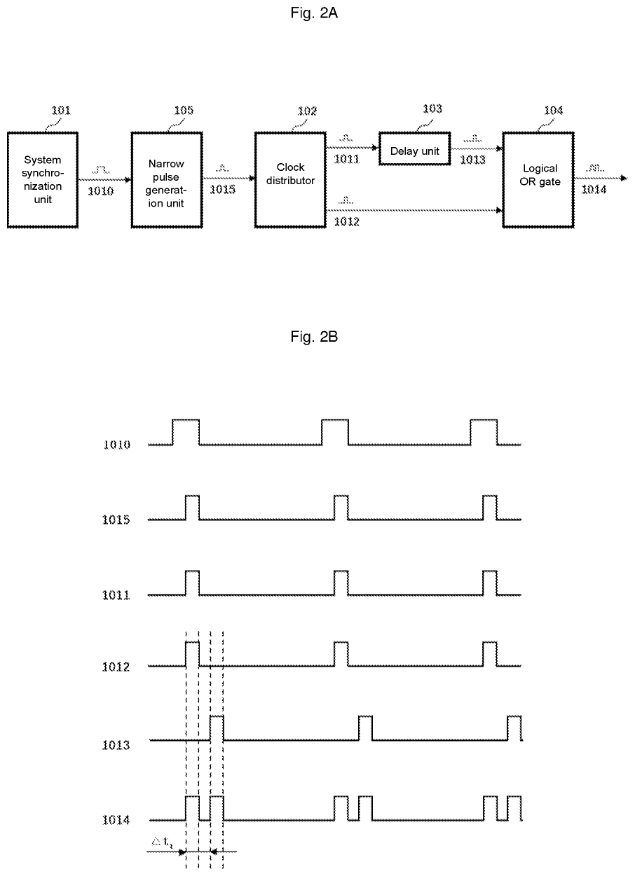

FIG. 2A is another schematic diagram of a gating apparatus for a single-photon detector according to an illustrative example of the disclosure. FIG. 2B is another schematic diagram of a signal time series of an operation process of a gating apparatus for a single-photon detector according to an illustrative example of the disclosure.

With reference to FIGS. 2A and 2B, the gating apparatus shown in FIG. 2A may include a narrow pulse generation unit 105 in addition to the system synchronization unit 101, the clock distributor 102, the delay unit 103 and the logical OR gate 104 shown in FIG. 1A. The narrow pulse generation unit 105 may be arranged between the system synchronization unit 101 and the clock distributor 102 and may be configured to narrow a pulse width of a periodic gating signal 1014. Under the condition that the pulse width of the gating signal exceeds a system threshold, the pulse width of the gating signal generated by the gating apparatus can satisfy operation requirements of the quantum communication system for the single-photon detector in a Geiger mode.

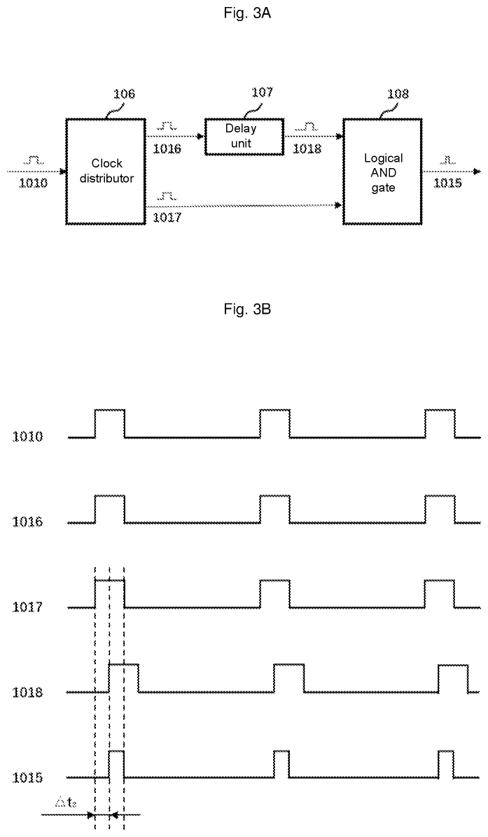

Implementation of the narrow pulse generation unit 105 will be described in detail with reference to FIGS. 3A and 3B.

FIG. 3A is a schematic diagram of a narrow pulse generation unit 105 in a gating apparatus for a single-photon detector according to an illustrative example of the disclosure. FIG. 3B is a schematic diagram of a signal time series of an operation process of a narrow pulse generation unit 105 in a gating apparatus for a single-photon detector according to an illustrative example of the disclosure.

With reference to FIGS. 3A and 3B, the narrow pulse generation unit 105 shown in FIG. 3A may include a clock distributor 106, a delay unit 107 and a logical AND gate 108.

In the narrow pulse generation unit 105 shown in FIG. 3A, the clock distributor 106 may be configured to divide the periodic gating signal 1010 into two identical periodic gating signals 1016 and 1017. The delay unit 107 may be configured to delay one periodic gating signal 1016, so that the one periodic gating signal 1016 and the other periodic gating signal 1017 are spaced apart by predetermined duration Δt₂, where the predetermined duration Δt₂ is smaller than the pulse width of the periodic gating signal. The logical AND gate 108 may be configured to perform an AND operation on the periodic gating signal 1018 delayed and the other periodic gating signal 1017 undelayed, so as to narrow the pulse width of the periodic gating signal.

It should be understood that although FIG. 3A is a schematic diagram of the narrow pulse generation unit 105 in the gating apparatus for a single-photon detector according to the illustrative example of the disclosure, the disclosure is not limited thereto, and other devices or other device combinations may be adopted for implementing the narrow pulse generation unit 105. The narrow pulse generation unit 105 may have devices more than those shown in FIG. 3A or fewer than those shown in FIG. 3A.

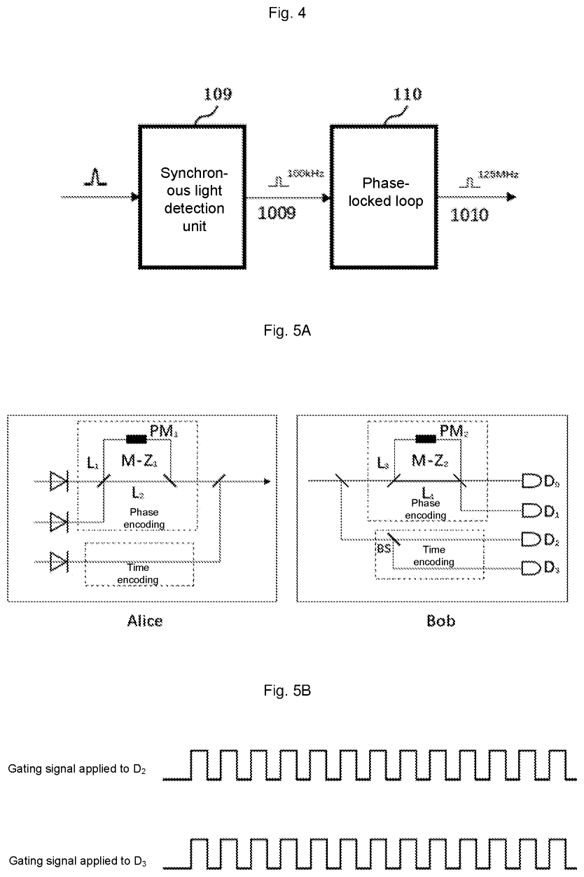

Implementation of the system synchronization unit 101 will be described in detail with reference to FIG. 4.

FIG. 4 is a schematic diagram of a system synchronization unit 101 in a gating apparatus for a single-photon detector according to an illustrative example of the disclosure.

With reference to FIG. 4, the system synchronization unit 101 in the gating apparatus for a single-photon detector according to the illustrative example of the disclosure may include a synchronous light detection unit 109 and a phase-locked loop 110.

In the system synchronization unit 101 shown in FIG. 4, the synchronous light detection unit 109 may be configured to convert synchronous light (that is, the synchronous light sent synchronously with the optical pulse in an encoded signal) received from the quantum communication system into a synchronous electrical signal, so as to obtain the clock 1009 of the quantum communication system. The phase-locked loop 110 may be configured to perform phase locking and frequency multiplication on the synchronous electrical signal, so as to obtain the periodic gating signal 1010 synchronized with the clock 1009 of the quantum communication system. As an instance, under the condition that the synchronous light is low frequency light, a synchronous electrical signal with a frequency including but not limited to 100 kHz may be converted into a periodic gating signal with a frequency including but not limited to 125 MHz by the system synchronization unit 101 shown in FIG. 4. In this way, a low frequency signal can be converted into a high frequency signal.

It should be understood that although FIG. 4 is a schematic diagram of the system synchronization unit 101 in the gating apparatus for a single-photon detector according to the illustrative example of the disclosure, the disclosure is not limited thereto, and other devices or other device combinations may be adopted for implementing the system synchronization unit 101. The system synchronization unit 101 may have devices more than those shown in FIG. 4 or fewer than those shown in FIG. 4.

FIG. 5A is a schematic diagram of a quantum communication system based on time phase encoding in the related art.

With reference to FIG. 5A, in the related art, the quantum communication system based on time phase encoding may include a terminal Alice and a terminal Bob. In the quantum communication system shown in FIG. 5A, an optical pulse sent from the terminal Alice may reach one of single-photon detectors D₀, D₁, D₂ and D₃ at the terminal Bob. An optical pulse that reaches the terminal Bob via paths (L₂, L₄) and (L₁, L₂) provided by unequal-arm interferometers M-Z₁ and M-Z₂ may not suffer light interference, and a optical pulse that reaches the terminal Bob via paths (L₁, L₄) and (L₂, L₃) provided by the unequal-arm interferometers M-Z₁ and M-Z₂ may suffer light interference. The terminal Alice and the terminal Bob may change an intensity of the optical pulse that suffers interference along with a phase difference by modulating phases of phase modulators PM₁ and PM₂, so as to implement phase encoding. In addition, the terminal Alice and the terminal Bob may also adjust time of the optical pulse, so as to implement time encoding.

In the related art, a optical pulse that carries phase codes may be randomly assigned to one of single-photon detectors D₀ and D₁ in the terminal Bob for detection. An optical pulse that carries time codes may be randomly assigned to one of single-photon detectors D₂ and D₃ in the terminal Bob for detection. As an instance, FIG. 5B is a schematic diagram of applying gating signals to single-photon detectors D₂ and D₃ respectively in the quantum communication system shown in FIG. 5A for detecting time codes carried by the optical pulse in the related art.

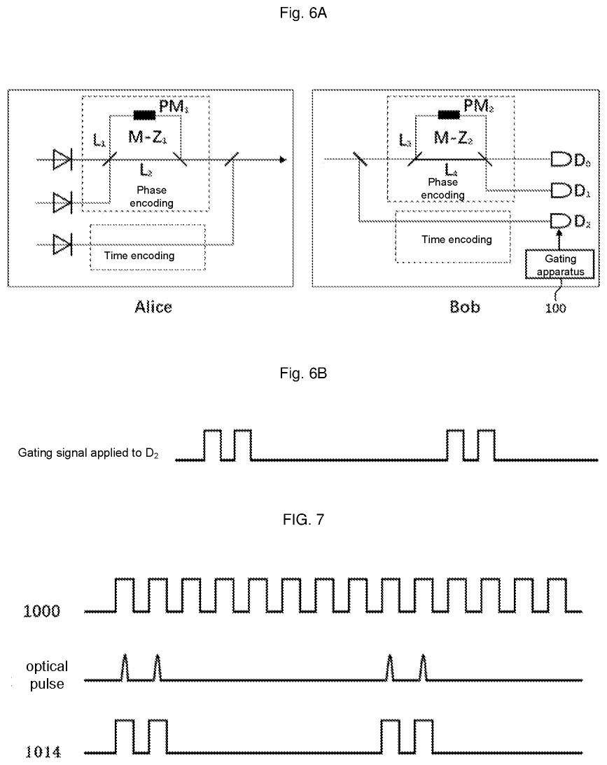

FIG. 6A is a schematic diagram of a quantum communication system based on time phase encoding according to an illustrative example of the disclosure.

With reference to FIG. 6A, the quantum communication system based on time phase encoding shown in FIG. 6A may include a terminal Alice and a terminal Bob. In the quantum communication system shown in FIG. 6A, an optical pulse sent from the terminal Alice may reach one of single-photon detectors D₀, D₁ and D₂ at the terminal Bob. An optical pulse that reaches the terminal Bob via paths (L₂, L₄) and (L₁, L₃) provided by unequal-arm interferometers M-Z₁ and M-Z₂ may not suffer light interference, and an optical pulse that reaches the terminal Bob via paths (L₁, L₄) and (L₂, L₃) provided by the unequal-arm interferometers M-Z and M-Z₂ may suffer light interference. The terminal Alice and the terminal Bob may change an intensity of the optical pulse that suffers interference along with a phase difference by modulating phases of PM₁ and PM₂, so as to implement phase encoding. In addition, the terminal Alice and the terminal Bob may also adjust time of the optical pulse, so as to implement time encoding.

In the quantum communication system shown in FIG. 6A, an optical pulse that carries phase codes may be randomly assigned to one of single-photon detectors D₀ and D₁ in the terminal Bob for detection. An optical pulse that carries time codes may be directly assigned to a single single-photon detectors D₂ in the terminal Bob for detection. As an instance, FIG. 6B is a schematic diagram of applying a gating signal to a single-photon detector D₂ in the quantum communication system shown in FIG. 6A by using a gating apparatus 100 for a single-photon detector according to an illustrative example of the disclosure for detecting time codes carried by an optical pulse.

It can be seen that, compared with the quantum communication system shown in FIG. 5A, the quantum communication system shown in FIG. 6A merely uses the single single-photon detector D₂ to detect the time code carried by the optical pulse by using the gating apparatus 100 for a single-photon detector according to the illustrative example of the disclosure. In this way, a number of single-photon detectors used in the quantum communication system can be decreased, a cost of system implementation can be decreased, and insertion loss (about 3 dB under normal circumstances) caused by using a polarization beam splitter (BS) shown in FIG. 5A can be further avoided.

It should be understood that although FIGS. 6A and 6B show instances of detecting the time codes carried by the optical pulse through the single single-photon detector D₂ and by using the gating apparatus 100 for a single-photon detector respectively according to the illustrative examples of the disclosure, the instances are merely schematic, and the disclosure is not limited thereto. For example, the gating apparatus 100 for a single-photon detector according to the illustrative example of the disclosure may also be used to detect the phase codes carried by the optical pulse through the single single-photon detector, and even appropriate modifications can be made to the gating apparatus 100 for a single-photon detector according to the illustrative example of the disclosure. For example, the gating apparatus shown in FIG. 1A may include additional devices (including but not limited to additional clock distributors, additional delay units or additional logical OR gates), such that each periodic gating signal sequence of the periodic gating signal sequences 1014 output by the gating apparatus 100 for a single-photon detector according to the illustrative example of the disclosure includes two or more gating signals, and the single single-photon detector can detect both the phase codes carried by the optical pulse and the time codes carried by the optical pulse accordingly.

FIG. 7 is a schematic diagram of a comparison between a periodic gating signal 1000 that is output in the related art and a periodic gating signal sequence 1014 that is output by a gating apparatus 100 for a single-photon detector according to an illustrative example of the disclosure.

It can be seen that the periodic gating signal sequence 1014 output by the gating apparatus 100 for a single-photon detector according to the illustrative example of the disclosure has a lower repetition frequency compared with the periodic gating signal 1000 output in the related art. In this way, a dark count and a after pulse count caused by a high repetition frequency in a high-frequency operation process of the single-photon detector in the quantum communication system can be effectively decreased, and the error rate of the quantum communication system during secret key generation can be greatly decreased.

Correspondingly, the disclosure further provides a quantum communication device (such as the terminal Bob shown in FIG. 6A) including the gating apparatus for a single-photon detector. According to the quantum communication device, a dark count and a after pulse count caused by using a periodic gating signal with a high repetition frequency in a high-frequency operation process by the single-photon detector in the quantum communication system can be effectively decreased, and the error rate of the quantum communication system during secret key generation can be greatly decreased. In addition, numbers of single-photon detectors and polarization beam splitters used in the quantum communication system can be significantly decreased, a cost of system implementation can be decreased, and insertion loss caused by using additional polarization beam splitters (BSs) as shown in FIG. 5A can be further avoided.

Although the disclosure have been shown and described with reference to preferred examples, it should be understood by those skilled in the art that various changes and modifications can be made to these examples without departing from the spirit and scope of the disclosure defined by the claims.

What is claimed is:

1. A gating apparatus for a single-photon detector, comprising:
a system synchronization unit, configured to obtain a periodic gating signal synchronized with a clock of a quantum communication system;
a clock distributor, configured to divide the periodic gating signal into two identical periodic gating signals;
a delay unit, configured to delay one periodic gating signal of the two periodic gating signals, so that the one periodic gating signal and the other periodic gating signal of the two periodic gating signals are spaced apart by predetermined duration, wherein the predetermined duration is an optical path difference between a long arm and a short arm of an unequal-arm interferometer used for phase encoding in the quantum communication system; and
a logical OR gate, configured to perform an OR operation on the one periodic gating signal delayed and the other periodic gating signal undelayed of the two periodic gating signals, so as to generate a periodic gating signal sequence synchronized with the clock of the quantum communication system, wherein gating signals in each gating signal sequence of the periodic gating signal sequence are spaced apart from each other by the predetermined duration, such that gating of the single-photon detector in the quantum communication system is activated for a optical pulse received by the single-photon detector.

2. The gating apparatus according to claim 1, wherein the quantum communication system is based on time phase encoding or based on phase encoding.

3. The gating apparatus according to claim 1, further comprising:
a narrow pulse generation unit, arranged between the system synchronization unit and the clock distributor, and configured to narrow a pulse width of the periodic gating signal.

4. The gating apparatus according to claim 3, wherein the narrow pulse generation unit comprises:
another clock distributor, configured to divide the periodic gating signal into another two identical periodic gating signals;
another delay unit, configured to delay one periodic gating signal of the another two periodic gating signals, so that the one periodic gating signal and the other periodic gating signal of the another two identical periodic gating signals are spaced apart by another predetermined duration, wherein the another predetermined duration is smaller than the pulse width of the periodic gating signal; and
a logical AND gate, configured to perform an AND operation on the one periodic gating signal delayed and the other periodic gating signal undelayed of the another two periodic gating signals, so as to narrow the pulse width of the periodic gating signal.

5. The gating apparatus according to claim 1, wherein the system synchronization unit comprises:
a synchronous light detection unit, configured to convert synchronous light received from the quantum communication system into a synchronous electrical signal, so as to obtain the clock of the quantum communication system; and
a phase-locked loop, configured to perform phase locking and frequency multiplication on the synchronous electrical signal, so as to obtain the periodic gating signal synchronized with the clock of the quantum communication system.

6. A quantum communication device, comprising a gating apparatus for a single-photon detector, and the gating apparatus comprises:
a system synchronization unit, configured to obtain a periodic gating signal synchronized with a clock of a quantum communication system;
a clock distributor, configured to divide the periodic gating signal into two identical periodic gating signals;
a delay unit, configured to delay one periodic gating signal of the two identical periodic gating signals, so that the one periodic gating signal and the other periodic gating signal of the two periodic gating signals are spaced apart by predetermined duration, wherein the predetermined duration is an optical path difference between a long arm and a short arm of an unequal-arm interferometer used for phase encoding in the quantum communication system; and
a logical OR gate, configured to perform an OR operation on the one periodic gating signal delayed and the other periodic gating signal undelayed of the two periodic gating signals, so as to generate a periodic gating signal sequence synchronized with the clock of the quantum communication system, wherein gating signals in each gating signal sequence of the periodic gating signal sequence are spaced apart from each other by the predetermined duration, such that gating of the single-photon detector in the quantum communication system is activated for a optical pulse received by the single-photon detector.

7. The quantum communication device according to claim 6, wherein the quantum communication system is based on time phase encoding or based on phase encoding.

8. The quantum communication device according to claim 6, wherein the gating apparatus further comprises:
a narrow pulse generation unit, arranged between the system synchronization unit and the clock distributor, and configured to narrow a pulse width of the periodic gating signal.

9. The quantum communication device according to claim 8, wherein the narrow pulse generation unit comprises:
another clock distributor, configured to divide the periodic gating signal into another two identical periodic gating signals;
another delay unit, configured to delay one periodic gating signal of the another two identical periodic gating signals, so that the one periodic gating signal and the other periodic gating signal of the another two identical periodic gating signals are spaced apart by another predetermined duration, wherein the another predetermined duration is smaller than the pulse width of the periodic gating signal; and
a logical AND gate, configured to perform an AND operation on the one periodic gating signal delayed and the other periodic gating signal undelayed of the another two periodic gating signals, so as to narrow the pulse width of the periodic gating signal.

10. The quantum communication device according to claim 6, wherein the system synchronization unit comprises:
a synchronous light detection unit, configured to convert synchronous light received from the quantum communication system into a synchronous electrical signal, so as to obtain the clock of the quantum communication system; and
a phase-locked loop, configured to perform phase locking and frequency multiplication on the synchronous electrical signal, so as to obtain the periodic gating signal synchronized with the clock of the quantum communication system.

11. The gating apparatus according to claim 1, wherein the clock of the quantum communication system comprises a clock of an encoded signal of the quantum communication system.
